(19) United States
(12) Patent Application Publication
(10) Pub. No.: US 2012/0103915 A1
(43) Pub. Date: May 3, 2012

(54) METHOD AND DEVICE FOR PURIFICATION OF ARSENIC CONTAMINATED WATER

(75) Inventor: Kalyan Kumar Das, Mumbai (IN)

(73) Assignee: TATA CONSULTANCY SERVICES LTD., Mumbai (IN)

(21) Appl. No.: 13/379,896

(22) PCT Filed: Mar. 23, 2010
(86) PCT No.: PCT/IN10/00173

§ 371 Date: Jan. 20, 2012

(30) Foreign Application Priority Data
Jun. 22, 2009 (IN) 1475/MUM/2009

(51) Int. Cl. C02F 1/52

(52) U.S. Cl. 210/724; 210/723; 210/198.1

(57) ABSTRACT

A method of purifying arsenic contaminated water is disclosed. The method comprises of adding to the arsenic contaminated water predetermined quantities of iron and alkali; and passing the water so obtained through a filter medium including rice husk ash. A device for purification of arsenic contaminated water is also disclosed.

The document generally relates to a method and device for purification of water. More particularly the document relates to a method and device for purification of arsenic contaminated water.

### BACKGROUND

Arsenic is a non-metallic element that comprises 0.00005% of the earth's crust. It is generally transported and distributed in nature through water. The concentration of arsenic in natural water varies widely and primarily depends on the forms in which arsenic occurs in the soil. A major source of arsenic intake by the population is through drinking water. Arsenic can also enter the human body through cereals, fruits and vegetables that have absorbed arsenic containing water. Prolonged exposure to arsenic even in small dosages leads to serious health hazards due to its toxicity and carcinogenicity. Exposure to arsenic leads to alterations in the skin and organs of the respiratory, gastrointestinal, cardiovascular and nervous systems.

Arsenic has been found in groundwater of about 20 countries around the world. Millions of people in India, Bangladesh and Nepal suffer due to acute arsenic poisoning. Recent reports suggest that as many as 450 million people in the Ganges basin could be affected by this deadly element. Arsenic knows no geographical boundaries and newer areas in Asia (including Pakistan, China, Taiwan, and Myanmar) are continuously coming under the danger zone.

In natural water, arsenic is present in inorganic forms and exists as two predominant species: arsenate [As (V)] and arsenite [As (III)]. The major arsenic species in surface water is As (V) while As (III) is the dominant arsenic species in groundwater since it is favored under reducing conditions. The concentrations of arsenic in the affected areas generally vary from 80 to 1000 ppb (parts per billion), typically around 200-30 ppb. It has been reported that As (III) is more toxic to biological system than As (V) [Ferguson, J. F. and Davis, J. “A Review of the Arsenic Cycle in Natural Waters”, Water Res., 6: 1259 (1972); Cullen, W. R. and Reimer, K. J. “Arsenic Speciation in the Environment”. Chem. Rev., 89:713-764, (1989); Korte, N. E. and Fernando, Q. “A Review of Arsenic (III) in Groundwater”, Crit. Rev. Environ. Control, 21(1): 1-39 (1991)]. The WHO guideline for maximum level of arsenic contaminant in drinking water is 10 ppb. The US Environmental protection Agency (USEPA) sets the drinking water standard for arsenic at less than 10 ppb. In India, the maximum permissible limit is 50 ppb but the desirable value is given as 10 ppb [Bureau of Indian Standards 2003:ISO 10500:1991, Edition 2.2 dated 23 Sep. 2003].

Most drinking water treatment processes attempt to remove colour, odour, suspended particles and microorganisms by a variety of processes such as sedimentations, flocculation/coagulation, filtration, disinfection and UV treatment. Unfortunately, these techniques are generally not suited for removal of chemical contaminants such as arsenic. Moreover, most treatment processes are directed at removing arsenate since arsenite is generally non-charged below pH 9.2 and therefore requires a step for converting As (III) to As (V).

Most of the current techniques reported in the literature for the removal of arsenic from drinking water are based on precipitation-coagulation, adsorption, membrane separation and ion exchange [Zeng, L, “Preparation of Iron (III) Oxide Adsorbent for Arsenic Removal”, paper presented at Globe 2002, Vancouver, BC, Mar. 13-15, 2002; Jekel, M. R. “Removal of Arsenic in Drinking Water Treatment”, in Arsenic in the Environment, Part I: Cycling and Characterization, Edited by Jerome O. Nriagu, John Wiley & Sons, Inc, 1994; Kartinen, E. O. (Jr.) and Martin, C. J. “An Overview of Arsenic Removal Processes”, Desalination, 103: 78-88 (1995); Bitner, M. J. and Chwirka, J. D. “Arsenic Removal Treatment Technologies for Drinking Water Supplies”, Proceeding of 39^{th} New Mexico Water Conference, 251-255, Albuquerque, N.M, 1994]. In a report by Frey, Michelle M. et al. entitled “National Compliance Assessment and Costs for the Regulation of Arsenic in Drinking Water”, University of Colorado at Boulder, USA, several methods have been evaluated for arsenic removal efficiency and cost. None of the methods described in the report achieved arsenic removal efficiencies greater than 95 percent. The precipitation-coagulation technique is costly and thus uneconomical for treatment of small volume of water, typically used in households. The membrane based techniques like reverse osmosis (RO) and electrodialysis (ED) are also very expensive and require infra-structural facilities generally not accessible to the rural population in developing countries. Furthermore, these techniques perform efficiently when As (III) is first oxidized to As (V) by an oxidizing agent. Efficiency of ion exchange can be adversely affected due to the presence of other ions such as sulphate, fluoride and nitrate. Adsorption methods for removal of arsenic are also limited by the type of adsorbents used. For instance, hydrous ferric oxide (FeOOH) can remove both As (V) and As (III). In contrast, activated alumina (AA) is only effective for the removal of As(V).

Some of the arsenic removal filters (for community water supply schemes) use both adsorption and coagulation-flocculation-sedimentation and filtration. The media used for removal of arsenic is crystalline granular ferric oxide, which is relatively expensive. The arsenic containing water passes through two-stage filtration—in the first stage, a bed of silica is employed to remove iron and in the second stage ferric oxide granules are employed for the removal of arsenic. In certain instances, arsenic containing ground water is pumped into a mixing chamber where oxidizing agents like bleaching powder or hypochlorite are added to oxidize As (III) to As (V) and Fe (II) to Fe (III). The water is then sent to another chamber where ferric alum solution is added and mixed with the water. In a clarifier, the hydrolysed product of ferric alum gets flocculated and settles down. Evidently, these techniques are based on elaborate flowsheet, require stringent process control and proper maintenance on a regular basis.

A few techniques are also available for household treatment of arsenic contaminated water. For instance, solar oxidation and removal of arsenic (SORAS) is a simple method that uses irradiation of water with sunlight in JPET or other UV-A transparent bottles to reduce arsenic levels in drinking water. This technique is based on photochemical oxidation of As (III) followed by precipitation of As (V) on Fe (III) oxides in the presence of a small amount of citrate/lemon juice. Groundwater in Bangladesh contains Fe (II) and Fe (III) and therefore, SORAS could reduce arsenic content at little cost. It can be readily adopted for household level treatment of small quantities of drinking water [Wegelin, M., Gechter, D., Hug, S., Mahamud, A., Motaleb, A.; SORAS—a simple arsenic removal process, Environ Sci Technol, 31, 2005-2011 (1997)]. But the method may not be efficient in the rainy season when sunlight is not so abundant.

In the three-kalsi method, a simple filtration assembly consisting of three pitchers is used for removing arsenic from groundwater in Bangladesh. The first kalsi has iron chips and coarse sand, the second kalsi has wood charcoal and fine sand, and the third kalsi is the collector for filtered water. It has been reported that the As (total) can be removed to a concentration below 10 ppb for most samples even at the highest input concentration of 1100 ppb As (total). The dissolved iron concentration decreased from average 6000 ppb to 200 ppb. [Khan A. H, Rasul H. B, Munir A K M, Habibudowla M, Alauddin M, Newaz S S and Hussain A; Appraisal of simple arsenic removal method for ground water of Bangladesh; J Environ. Sci., A 35(7), 1021-1041 (2000]. However, this is a cumbersome method for the removal of arsenic.

A number of processes for removal of arsenic from groundwater have been disclosed in the patent literature. A few of these are described below:

U.S. Pat. No. 6,461,535 discloses a process for removing arsenic from ground water for use in remote dwellings. The process involves contacting the water containing arsenic with a composition comprising of clay, a coagulant and chlorine, wherein the clay and the coagulant is capable of forming a coagulant/colloidal mixture that absorbs arsenic. The coagulant/colloidal mixture is separated from the water.

U.S. Pat. No. 6,368,510 describes a method and apparatus for removing arsenic from water at the point of entry or point of use, mainly for residential application. The method involves a first stage having a manganese greensand oxidizer to convert arsenite present in the water to arsenate and a second stage for passing the water through an anion exchange or a reverse osmosis system. The method involves fairly sophisticated techniques that are generally not implementable in rural areas. Furthermore, the regeneration of the oxidizer and anion exchange resin requires skilled manpower.

U.S. Pat. No. 5,575,919 describes a method for removing arsenic from drinking water by using finely divided metallic iron in the presence of powdered elemental sulfur or other sulfur components such as manganese sulfide. This is followed by an oxidation step to effect arsenic recovery as a precipitate which is separated from the water. This method requires a mixing vessel and use of sulfur modified iron, and the addition of acid as well as other chemicals requiring precision monitoring.

The inventions described in these and other patents have many drawbacks such as multiple unit operations, specialised equipment, high initial and operating costs, speciality and expensive chemicals, trained manpower for maintenance of the equipment etc. As a consequence, these solutions are generally not suitable for low-cost implementation in scaled-down versions of arsenic removal filters/devices/processes for individual households.

Metal hydroxide coated sands for removal of multivalent ions especially arsenic from water has been reported [Lukasik, Jerzy (1998), The Removal of Microbial and Chemical Contaminants from Aqueous Solutions by Particles Coated with Iron and Aluminum Hydroxides, Ph D Dissertation, University of Florida; Benjamin, M M, Sletten, R S, Bailey, R P, and Bennett, T (1996), Sorption and Filtration of Metals Using Iron-Oxide-Coated Sand, Water Research, 30(11), 2609-2620; Joshi, A and Chaudhuri, M (1996), Removal of Arsenic from Ground Water by Iron-Oxide-Coated Sand, ASCE Journal of Environmental Engineering, 122(8), 769-771 and Lo, S., Jeng, H., and Lai, C (1997) Characteristics and Adsorption Properties of Iron-Coated Sand, Water Sc. Tech., 35(7), 63-70].

Although sand coated with ferric hydroxide does remove arsenic, there is a definite limitation on its performance, which is primarily due to its relatively low surface area. The applicant previously developed a filter for removal of arsenic from drinking water based on coating of rice husk ash (RHA) with iron oxide precipitate using a patented process [Indian patent number 206230]. One limitation of this method is the lack of an end of life indicator._The only indication is a gradual lowering of the output water flowrate, that eventually results in negligible flow of water though the filter. Another limitation of the process is that coated rice husk ash needs to be pretreated before being prepared for filtration.

There is therefore, a need to develop a method that is simple to use and cost effective. More over the method should be such that it removes both As(III) and As(V) effectively from water.

### SUMMARY

The invention relates to a method of purifying arsenic contaminated water, the method comprises of adding to the arsenic contaminated water predetermined quantities of iron and alkali; and passing the water so obtained through a filter medium including rice husk ash.

The invention also relates to a method of purifying arsenic contaminated water, the method comprising adding to the arsenic contaminated water predetermined quantities of iron and potassium permanganate, and passing the water so obtained through a filter medium including rice husk ash.

The invention also relates to a method of purifying arsenic contaminated water comprising adding an iron salt and an alkali to the water, the quantities of iron salt and alkali based on a reference chart tabulating pre-determined quantities of iron and alkali to be added to water for a range of arsenic quantities present in the water, the pre-determined quantities of iron and alkali based on the subsequent passage of water through a filter medium including rice husk ash.

The invention also relates to a device for purification of arsenic contaminated water, the device comprising a container for receiving arsenic contaminated water, a means for adding reagents to the arsenic contaminated water in the chamber, the reagents including iron salt, potassium permanganate and an alkali, and a filtration chamber comprising an inlet for receiving water from the container and an outlet for purified water, the filtration chamber including a filter medium formed of rice husk ash.

### BRIEF DESCRIPTION OF ACCOMPANYING DRAWINGS

The accompanying drawings illustrate the preferred embodiments of the invention and together with the following detailed description serve to explain the principles of the invention.

FIG. 1: illustrates the effect of permanganate on the percentage removal of arsenic at different iron concentrations

FIG. 2: tabulates the effect of permanganate on the percentage removal of arsenic at different iron concentrations

FIG. 3: tabulates the amount of sodium hydroxide required to be added in water in relation to the ferric salt for maintaining pH of water at 7.

FIG. 4: illustrates a ready reference chart in accordance with an embodiment of the invention.

### DETAILED DESCRIPTION

To promote an understanding of the principles of the invention, reference will be made to the embodiment and specific language will be used to describe the same. It will nevertheless be understood that no limitation of scope of the invention is thereby intended, such alterations and further modifications in the described process and such further applications of the principles of the inventions as disclosed therein being contemplated as would normally occur to one skilled in art to which the invention relates.

A method for purification of water is disclosed. More particularly a method for purification of arsenic contaminated water is disclosed.

The method for purifying arsenic contaminated water comprises of adding to the arsenic contaminated water iron and alkali and then passing the water so obtained through a filter bed including rice husk ash.

In accordance with an alternate embodiment, the method for purifying arsenic contaminated water comprises of adding to the arsenic contaminated water iron and potassium permanganate and then passing the water so obtained through a filter bed including rice husk ash.

Arsenic is removed from water via two mechanisms: adsorption and co-precipitation. First, soluble iron present in the water is oxidized to form iron hydroxide precipitates. The As (III) present in water is also oxidized to As (V) by potassium permanganate. The As (V) and/or As (III) then adsorb onto the iron hydroxide precipitates forming an insoluble iron hydroxy arsenic species which is ultimately filtered through the filter medium. The mechanism for removal of arsenic from water is illustrated in the exemplified reactions:

Iron hydroxide precipitation

FeCl₃+H₂O [symbol] Fe(OH)₃ 1.

Oxidation of As(III)

H⁺+H₃AsO₃+MnO₄⁻→Mn₂⁺+H₃AsO₄+H₂O 2.

Iron-As complex

Fe(OH)₃(s)+H₃AsO₄ [symbol] FeAsO₄.2H₂O+H₂O 3.

In accordance with an aspect, iron is added to the water in the form of an iron salt along with an alkali.

The iron salt, alkali and potassium permanganate are added to the water such that the pH of the water is maintained in the range of 6 to 8.

Pre-determined quantities of iron salt, potassium permanganate and alkali are added to the water. In accordance with an aspect, amount of iron added to the water is such that the ratio of iron to arsenic is in the range of 5:1 to 30:1 and preferably the ratio of iron to arsenic is in the range of 15:1 to 20:1.

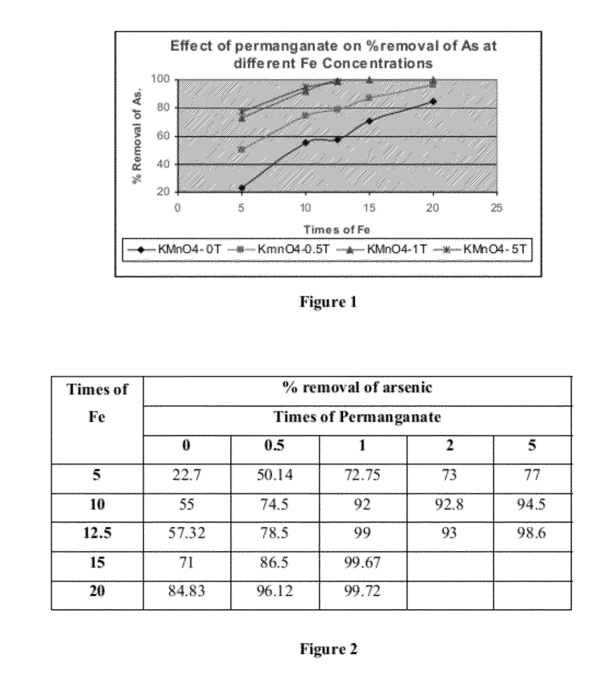

In accordance with an aspect, the ratio of iron to potassium permanganate that is required to be added to the arsenic contaminated water depends on the amount of iron added. The ratio of iron to potassium permanganate added to water is in the range of 30:1 to 5:1 and preferably in the range of 20:1 to 10:1. FIGS. 1 and 2 illustrate the effect of permanganate on percentage removal of arsenic at different concentrations of iron.

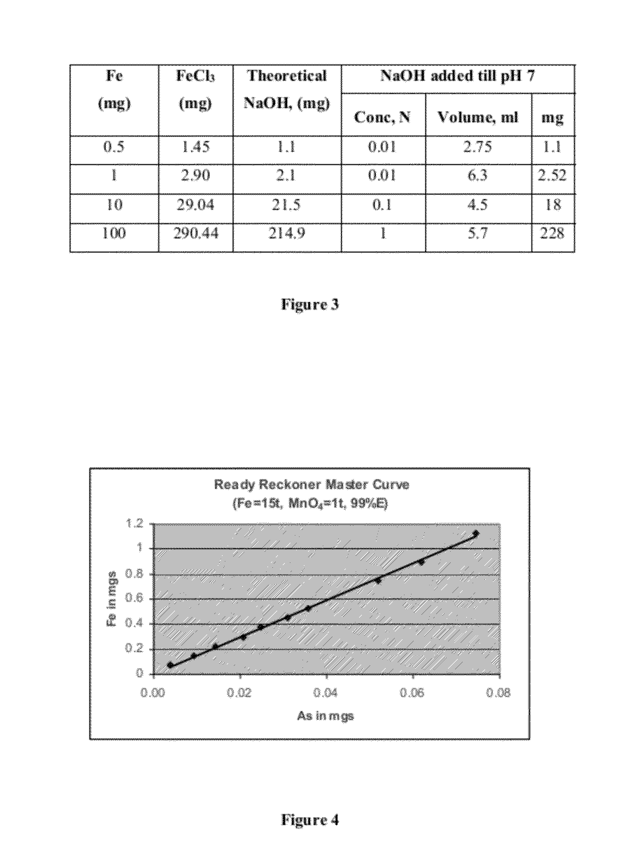

The amount of alkali added to the water should be such that the pH of the water is maintained between 6 to 8. The amount of alkali required to be added to the water depends upon the amount of iron that is added to the water. In accordance with an aspect the ratio of iron to alkali is in the range of 1:1.5 to 1:3 to maintain the pH of the contaminated water between 6 to 8. By way of example, FIG. 3 tabulates the amount of sodium hydroxide required to be added to arsenic contaminated water in relation to the ferric salt for maintaining the pH of water at 7. By way of a specific example, for each unit of iron that is added to the water, 2.5 units of sodium hydroxide is required to maintain the pH water at approximately 7.

In accordance with an aspect, the quantities of iron salt, potassium permanganate and alkali to be added to the arsenic contaminated water are determined from a reference chart. The reference chart facilitates the calculation of pre-determined quantities of iron, potassium permanganate and consequently the amount of alkali to be added to water for a range of arsenic quantities present in the water. The pre-determined quantities of iron, potassium permanganate and alkali are based on the subsequent passage of water through a filter medium including rice husk ash. The reagent chart may also include the quantity of arsenic present in water of different geographical regions. By way of a specific example, a reference chart is illustrated in FIG. 4.

The method for purifying arsenic contaminated water comprising of adding to the predetermined quantities of ferric salt, sodium hydroxide and potassium permanganate such that the pH of the water is maintained between 6 to 8 and passing the water so obtained through a filter medium including rice husk ash.

The rice husk ash that may be used for filtration of water may be any rice husk ash that is produced by burning rice husk. The rice husk ash may be produced by burning rice husk in heaps, in a step grate furnace, fluidized bed furnace or tube-in-basket (TiB) burner. The rice husk ash may also be obtained from boilers and brick kiln, provided it is free of unburnt husk and wood tar, grit, stone, and fused lumps of silica.

On combustion, the rice husk ash residue contains 75-95% silica, 4-12% carbon and the rest comprising various metal oxides such as alkali, alkali earth metal and ion oxides. On account of its crypto-crystalline or amorphous and highly porous structure, the BET (Brunauer Emmett Teller) surface area of rice husk ash may be as high as 80-100 square meters per gram, depending on the conditions employed for the combustion of rice husk. The particle size of rice husk ash may be in the range of 10 microns to 500 microns. High surface area and porosity of rice husk ash makes it an effective filtration medium.

In accordance with an aspect the filtration medium may include in addition to rice husk ash, other filler material such as sand, or activated carbon.

Rice husk when used as a filter medium due to its high surface area and porosity modulates the flow of arsenic contaminated water and the reagents through the filter medium. The filtration medium, therefore, provides enough residence time for the reactions to occur without the need of any external stirring. Moreover, rice husk ash also traps any other suspended solids, and microorganism as well as odour and colour thereby providing clear output water.

The iron salt that may be added to the water includes but is not limited to ferric chloride, ferric acetate, ferric lactate, ferric ammonium sulphate, ferric ammonium chloride, ferric citrate, ferric hydroxide, ferric oxide, ferrous chloride, ferrous acetate, ferrous lactate, ferrous ammonium sulphate, ferrous ammonium chloride, ferrous citrate, ferrous hydroxide or ferrous oxide alone or in combination.

The alkali that may be added to the water includes but is not limited to sodium hydroxide, potassium hydroxide or calcium hydroxide alone or in combination.

A device for purification of arsenic contaminated water is disclosed. The device comprises of a container for receiving arsenic contaminated water and a means for adding reagents to the arsenic contaminated water in the chamber. The reagents include iron salt, potassium permanganate and an alkali. The device also includes a filtration chamber comprising an inlet for receiving water from the container and an outlet for the purified water, the filtration chamber includes a filtration medium formed of rice husk ash.

In accordance with an aspect, the device further comprises of a reagent chart. The reagent chart tabulates pre-determined quantities of iron, potassium permanganate and indicates the amount of alkali to be added to water for a range of arsenic quantities present in the contaminated water. The pre-determined quantities of iron, potassium permanganate and alkali are based on the subsequent passage of water through the filter medium formed of rice husk ash. The reagent chart may also include the quantity of arsenic present in water of different geographical regions.

In accordance with an aspect, the means for adding the reagents includes a dispensing means for dispensing calibrated quantities of the reagents to the water in the chamber.

### Specific Embodiments are Described Below

A method of purifying arsenic contaminated water comprising adding to the arsenic contaminated water predetermined quantities of iron and alkali, and passing the water so obtained through a filter medium including rice husk ash.

Such method(s) wherein the addition of iron includes the addition of an iron salt.

Such method(s) wherein the iron and alkali are added such that the pH of the water is maintained in the range of 6 to 8.

A method of purifying arsenic contaminated water comprising adding to the arsenic contaminated water predetermined quantities of iron and potassium permanganate, and passing the water so obtained through a filter medium including rice husk ash.

Such method(s) wherein the addition of iron includes the addition of an iron salt and an alkali.

Such method(s) wherein addition of iron includes the addition of an iron salt and an alkali, the iron salt, alkali and potassium permanganate are added such that the pH of the water is maintained in the range of 6 to 8.

A method of purifying arsenic contaminated water comprising adding an iron salt and an alkali to the water, the quantities of iron salt and alkali based on a reference chart tabulating pre-determined quantities of iron and alkali to be added to water for a range of arsenic quantities present in the water, the pre-determined quantities of iron and alkali based on the subsequent passage of water through a filter medium including rice husk ash.

Such method(s) wherein the process further comprising adding to the arsenic contaminated water potassium permanganate comprising adding an iron salt, potassium permanganate and an alkali to the water, the quantities of iron salt, potassium permanganate and alkali based on a reference chart tabulating pre-determined quantities of iron, potassium permanganate and alkali to be added to water for a range of arsenic quantities present in the water, the pre-determined quantities of iron, potassium permanganate and alkali based on the subsequent passage of water through a filter medium including rice husk ash.

Such method(s) wherein, the iron salt is any of ferric chloride, ferric acetate, ferric lactate, ferric ammonium sulphate, ferric ammonium chloride, ferric citrate, ferric hydroxide, ferric oxide, ferrous chloride, ferrous acetate, ferrous lactate, ferrous ammonium sulphate, ferrous ammonium chloride, ferrous citrate, ferrous hydroxide or ferrous oxide alone or in combination.

Such method(s) wherein the alkali may be any of sodium hydroxide, potassium hydroxide or calcium hydroxide alone or in combination.

Such method(s) wherein the rice husk ash has a size in the range of 10 to 500 microns.

Such method(s) wherein, the ratio of iron to arsenic is in the range of 5:1 to 30:1 and preferably the ratio of iron to arsenic is in the range of 10:1 to 20:1.

Such method(s) wherein the ratio of iron to potassium permanganate is in the range of 30:1 to 5:1, and preferably the ratio of iron to potassium permanganate is in the range of 10:1 to 20:1.

Such method(s) wherein the ratio of iron to alkali is in the range of 1:1.5 to 1:3.

### Further Specific Embodiments are Described Below

A device for purification of arsenic contaminated water, comprising a container for receiving arsenic contaminated water, a means for adding reagents to the arsenic contaminated water in the chamber, the reagents including iron salt, potassium permanganate and an alkali, and a filtration chamber comprising an inlet for receiving water from the container and an outlet for purified water, the filtration chamber including a filter medium formed of rice husk ash.

Such device(s) further comprising of a reagent chart tabulating pre-determined quantities of iron, potassium permanganate and alkali to be added to water for a range of arsenic quantities present in the water, the pre-determined quantities of iron, potassium permanganate and alkali based on the subsequent passage of water through the filter medium formed of rice husk ash.

Such device(s) wherein the reagent chart further comprises of indicative quantities of arsenic present in water of different geographical regions.

Such device(s) wherein the means for adding the reagents includes a dispensing means for dispensing calibrated quantities of the reagents to the water in the chamber.

### INDUSTRIAL APPLICABILITY

The method as disclosed allows for a simple and effective system for removal of arsenic from water. The method as disclosed is inexpensive and uses raw materials that are easily available. The method allows the efficient removal of both As(III) and As(V) resulting in almost zero arsenic in the output water which is otherwise very hard to achieve. Moreover the method and device described are simple to implement as it does not require monitoring because, as long as the reagents are available, the method will work. The method disclosed also requires less iron as compared to other purification techniques including the applicant's previous method of coated rice husk ash.

In conventional systems that use iron hydroxide coated substrates, iron oxides and hydroxides are prepared in advance and then coated onto the substrate. Such iron oxide and hydroxide prepared and coated is said to be “aged”. In the method and system disclosed iron hydroxide is prepared in-situ. The freshly prepared iron hydroxide as provided by this method is highly reactive and thus efficient for removal of arsenic from water. It is believed that this results in a decrease in the amount of iron required for removal of arsenic from water.

Also there is no build up of iron in the output water. Moreover, the use of permanganate allows efficient removal of As(III) as well as As(V) by oxidising As(III) to As(V) Potassium permanganate also oxidises any soluble iron present in the water. Moreover permanganate also eliminates any microorganism that may be present in water.

With reference to FIGS. 1 and 2, it is observed that without the addition of permanganate (KMnO₄-0 times), the arsenic in water is removed. However, the removal efficiency is low. Significant improvement in the removal of arsenic is observed when the KMnO₄ is added in a quantity of 0.5 and 1 time arsenic concentration. However at a concentration greater than 1 time, there is no further improvement.

It has been further observed that the ratio of iron and permanganate added to the water is critical. For example, use of 5 times permanganate and 5 times iron is not efficient. By way of a specific example, at 15 times iron concentration, permanganate can greatly improve the removal efficiency from 70% (no KMnO₄) to 87% (0.5 times KMnO₄) to 100% (1 time KMnO₄). The synergistic beneficial effect of iron hydroxides coupled with permanganate addition and subsequent flow through the rice husk ash bed is novel.

Rice husk is a perennially renewable agro-waste available at virtually no cost wherever rice paddy is grown. Rice husk ash is thus a suitable water purifier material as it contains an activated surface with abundant pores, has a large surface area, is easily available and is cheap. Rice husk when used as a filter medium modulates the flow of water over the rice husk ash. Passage of the reagents and arsenic contaminated water through a mesoporous material like rice husk ash provides enough residence time for the reactions to occur. Moreover, rice husk ash also traps any other suspended solids, and microorganism as well as odour and colour thereby providing clear output water.

It is believed that rice husk ash due to its unique structure and surface properties facilitates the optimum utilisation of the reagents. As the rice husk ash column offers resistance to the flow of water, it thus provides the necessary resistance time for the reagents to react and thus facilitates the removal of arsenic. It is also believed that maintaining the pH of the reaction in the range of 6-8 assists in the efficiency of the purification.

The rice husk ash bed which acts as a filtration medium cum reactor will accumulate ferric hydroxide—arsenic complex which will need periodic simple cleaning by water. This is to ensure the continuous use of the RHA bed for a longer period. After a couple of months use, the RHA bed itself can be replaced at a nominal cost. The spent ferric hydroxide arsenic complex is non-toxic solid waste. Its volume being small the disposal is less problematic. Under normal environmental conditions, no leaching of arsenic takes place out of the spent ferric hydroxide-arsenic precipitate.

Moreover, the combination of maintaining the pH in the range of 6-8 and the presence of rice husk ash in the filter medium synergistically improves the efficiency of the filtration and reduces the amount of reagents required.

The device as disclosed is a simple device that is inexpensive and simple to use. Moreover the device is such that it does not require any electricity or running water.

1. A method of purifying arsenic contaminated water comprising:
adding to the arsenic contaminated water predetermined quantities of iron and alkali; and
passing the water so obtained through a filter medium including rice husk ash.

2. A method as claimed in claim 1, wherein the addition of iron includes the addition of an iron salt.

3. A method as claimed in claim 1, wherein the iron and alkali is added such that the pH of the water is maintained in the range of 6 to 8.

4. A method of purifying arsenic contaminated water comprising:
adding to the arsenic contaminated water predetermined quantities of iron and potassium permanganate; and
passing the water so obtained through a filter medium including rice husk ash.

5. A method as claimed in claim 4, wherein the addition of iron includes the addition of an iron salt and an alkali.

6. A method as claimed in claim 4, wherein addition of iron includes the addition of an iron salt and an alkali, the iron salt, alkali and potassium permanganate are added such that the pH of the water is maintained in the range of 6 to 8.

7. A method of purifying arsenic contaminated water comprising:
adding an iron salt and an alkali to the water, the quantities of iron salt and alkali based on a reference chart tabulating pre-determined quantities of iron and alkali to be added to water for a range of arsenic quantities present in the water, the pre-determined quantities of iron and alkali based on the subsequent passage of water through a filter medium including rice husk ash.

8. A method as claimed in claim 7 wherein the process further comprising adding to the arsenic contaminated water potassium permanganate, the quantities of iron salt, potassium permanganate and alkali based on a reference chart tabulating pre-determined quantities of iron, potassium permanganate and alkali to be added to water for a range of arsenic quantities present in the water, the pre-determined quantities of iron, potassium permanganate and alkali based on the subsequent passage of water through a filter medium including rice husk ash.

9. A method as claimed in claim 2, wherein, the iron salt is any of ferric chloride, ferric acetate, ferric lactate, ferric ammonium sulphate, ferric ammonium chloride, ferric citrate, ferric hydroxide, ferric oxide, ferrous chloride, ferrous acetate, ferrous lactate, ferrous ammonium sulphate, ferrous ammonium chloride, ferrous citrate, ferrous hydroxide or ferrous oxide alone or in combination.

10. A method as claimed in claim 1, wherein the alkali may be any of sodium hydroxide, potassium hydroxide or calcium hydroxide alone or in combination.

11. A method as claimed in claim 1, wherein the rice husk ash has a size in the range of 20 to 500 microns.

12. A method as claimed in claim 1, wherein, the ratio of iron to arsenic is in the range of 5:1 to 30:1.

13. A method as claimed in claim 8, wherein the ratio of iron to potassium permanganate is in the range of 30:1 to 5:1.

14. A method as claimed in claim 1, wherein the ratio of iron to alkali is in the range of 1:1.5 to 1:3.

15. A device for purification of arsenic contaminated water, comprising
a container for receiving arsenic contaminated water;
a means for adding reagents to the arsenic contaminated water in the chamber, the reagents including iron salt, potassium permanganate and an alkali; and
a filtration chamber comprising an inlet for receiving water from the container and an outlet for purified water, the filtration chamber including a filter medium formed of rice husk ash.

16. A device as claimed in claim 15, further comprising of a reagent chart tabulating pre-determined quantities of iron, potassium permanganate and alkali to be added to water for a range of arsenic quantities present in the water, the pre-determined quantities of iron, potassium permanganate and alkali based on the subsequent passage of water through the filter medium formed of rice husk ash.

17. A device as claimed in claim 16, wherein the reagent chart further comprises of indicative quantities of arsenic present in water of different geographical regions.

18. A device as claimed in claim 15, wherein the means for adding the reagents includes a dispensing means for dispensing calibrated quantities of the reagents to the water in the chamber.

19. (canceled)

20. (canceled)

21. A method as claimed in claim 7, wherein, the iron salt is any of ferric chloride, ferric acetate, ferric lactate, ferric ammonium sulphate, ferric ammonium chloride, ferric citrate, ferric hydroxide, ferric oxide, ferrous chloride, ferrous acetate, ferrous lactate, ferrous ammonium sulphate, ferrous ammonium chloride, ferrous citrate, ferrous hydroxide or ferrous oxide alone or in combination.

22. A method as claimed in claim 7, wherein the alkali may be any of sodium hydroxide, potassium hydroxide or calcium hydroxide alone or in combination.

23. A method as claimed in claim 7, wherein the rice husk ash has a size in the range of 20 to 500 microns.

24. A method as claimed in claim 7, wherein, the ratio of iron to arsenic is in the range of 5:1 to 30:1.
